(19) United States
(12) Patent Application Publication
(10) Pub. No.: US 2017/0030853 A1
(43) Pub. Date: Feb. 2, 2017

(54) Apparatus, Method and System for Distributed Chemical or Biological to Digital Conversion to Digital Information Using Radio Frequencies

(71) Applicants: John William Hodges, JR., Ocoee, FL (US); Marc Edward Rippen, Treasure Island, FL (US)

(72) Inventors: John William Hodges, JR., Ocoee, FL (US); Marc Edward Rippen, Treasure Island, FL (US)

(21) Appl. No.: 14/884,092

(22) Filed: Oct. 15, 2015

Related U.S. Application Data
(60) Provisional application No. 62/082,735, filed on Nov. 21, 2014.

(51) Int. Cl. G01N 27/27; G06K 7/10

(52) U.S. Cl. CPC G01N 27/27; G06K 7/10366

(57) ABSTRACT

An Apparatus, Method and System for sensing Chemical and Biological information and converting said information into the electronic digital domain for relay in a radio frequency identification (RFID) tag embedded in a dielectric medium. The apparatus consists of two parts; 1) a single coordinator apparatus providing power, control, signal processing and communications functions wirelessly to 2) a large number of chemical and temperature sensor tags embedded in a lossy dielectric medium that do not contain batteries and cannot function without the coordinator apparatus. The coordinator apparatus further acts as a digital information bridge to outside systems with the data obtained from the large number of sensor tags to the system. A First Method using said apparatus whereby the single coordinator apparatus synchronizes and provides clocking for and commands a large number of sensor tags and further queries the large number of sensor tags simultaneously and the digital representation of a concentration of a chemical or biological analyte acting on each sensor or temperature of the sensor apparatus are collectively obtained. A Second Method utilizes a plurality of sensor apparatus containing analog to digital converters in conjunction with said chemical and biological reversible chemoresistive sensors to transmit encoded chemical and biological information to a single signal processing function over radio frequency electromagnetic waves utilizing code division multiple access whereby only the ID number of those sensor apparatus measuring a higher value than a variable reference value transmit simultaneously. An arithmetic despreading operation is performed so that a probability that a given set of sensor tags is measuring a value higher value than a variable reference value is obtained. The variable reference value for the set is assigned a bit weight competing the chemical, or temperature to digital conversion process. In succeeding operations, the Second Method may vary the variable reference value at each of the sensor apparatus to form a successive approximation of the chemical, or temperature to digital conversion information. A Third Method for optimally adjusting the electrical characteristics to match the physical characteristics of the dielectric medium is provided. A System whereby organizes said plurality of sensor tags each reporting chemical, biological and temperature information into a colony whereby said system obtains data from thousands of Colony Member tags thereby harvested by the Colony Coordinators and further the data from thousands of Colony whereby the System organizes groups of these Colonies each reporting chemical, biological and temperature information into Groups of Colony whereby the System decodes the temperature chemical and biological information and processes the information from each of the Colony Member sensor tags in a time correlated database to form an electronic digital domain representation of said chemical, biological and temperature information for further analysis. Said System formats the time series database based on the interpreted chemical and biological information for relay back to a decision point thus creating actionable intelligence of decay at the carton and item level. Thereby using the above, Apparatus, Method and System collecting data from inside an electrical dielectric medium of interest for the temperature, concentration of a chemical or biological analyte located physically inside each carton or item and relaying this data to external information processes the object of the invention is thus fulfilled.

### RELATED APPLICATIONS

This patent application claims priority to, and incorporates by reference in its entirety U.S. Provisional Application No. 62/082,735 entitled “An Apparatus, Method and System for Distributed Chemical or Biological to Digital Conversion to Digital Information Using Radio Frequencies”, by John W Hodges, et al., filed on Nov. 21, 2014

### FIELD OF THE INVENTION

The invention relates to temperature, chemical and biological sensing RFID tags.

### BRIEF DESCRIPTION OF THE DRAWINGS

FIG. 1 Shows an Illustrative diagram of the invention distributed Chemical and Biological to Digital Conversion, Colony Members and Colony Coordinator, in accordance with the present invention.

FIG. 2 Shows an Illustrative diagram of the current state of the art.

FIG. 3 Shows an Illustrative diagram of the inventive concept in accordance with the present invention.

FIG. 4 Shows an Illustrative diagram of the inventive concept with simplified for clarity RF radiation patterns inside a pallet as a dielectric in accordance with the present invention.

FIG. 5 Shows a Circuit Block Diagram of the Apparatus Part A in accordance with the present invention.

FIG. 6 Shows a Circuit Block Diagram of the Apparatus Part B in accordance with the present invention.

FIG. 7 Shows a Flow Diagram of the First Method in accordance with the present invention.

FIG. 8 Shows a Flow Diagram of the Second Method in accordance with the present invention.

FIG. 9 Shows a Graphical Illustration of the Second Method in accordance with the present invention.

### BACKGROUND OF THE INVENTION

Every day, millions of tons of perishable goods are produced, transported, stored or distributed worldwide. These products are considered perishable because the internal biological and chemical processes continue after harvesting or manufacture. These products can be food items like fruit, vegetables, flowers, fish, meat and dairy products or medical products like drugs, blood, vaccines, organs, plasma and tissues. Some chemicals and electronic components are also sensitive. All of these products can have their properties or quality change rapidly when faced with inadequate environmental conditions during transport and storage. Even with today's network of refrigerated rail cars, trucks, and intermodal containers, shippers of fresh produce, frozen foods, temperature-sensitive liquids, and other perishable goods face numerous hurdles to ensure that their products arrive on time, unspoiled, and with adequate remaining shelf life. In industry, this network is called the Cold Chain.

For just one product sector, the cost of food spoilage totals more than $35 billion annually, according to a Forbes Magazine report. Produce is a living, breathing commodity, which emits heat and carbon dioxide. The risks of a failure at any point in the process from field to table can cause excessive ripening, weight loss, softening, color and texture changes, physical degradation and bruising, and attack by rot and molds. These factors affect freshness, desirability, and marketability. Strict temperature control throughout the supply chain can minimize the risk of food-borne illnesses because low temperatures drastically reduce the growth rate of most human pathogens.

In the U.S. alone, spoilage and waste in the food supply chain result in the loss of 23% to 25% of fruits and vegetables post-harvest, according to ChainLink Research. Furthermore, the research firm reports that 25% to 50% of the total economic value is lost because of reduced quality of products in the supply chain. There are less tangible costs as well such as: the costs of being out-of-stock of an item due to unplanned spoilage; the cost of overstocking items to avoid being out-of-stock; lost margin from price discounting and brand damage from lack of trust in product shelf life.

What happens when these products fail to make the grade? They turn into waste. For years, it's been considered a cost of doing business . . . waste just happens. For business, these perishable goods invariably contribute the highest income; ironically, they are also responsible for the highest level of waste and economic loss. Waste does not scale well, the larger the organization, the greater percentage of products lost to waste than at a smaller organization.

The causes of the spoilage and waste losses are numerous, but about half the loss is due to variations in temperature and half to other processes. Waste begins in the field or factory and needs to be managed from harvest or manufacturing through to delivery to the retail store. Every year in the US, there are approximately 7.59 million truckloads of perishable goods carried on 182 million pallets in 4.37 billion boxes with values up to $85,000 per pallet. This is a very large logistics problem spanning the US, Canada and Mexico and margins are razor thin in the shipping industry.

Industry is demanding a solution to spoilage and waste. Knowledge is power and all stakeholders need to equip themselves with actionable data about the quality and condition of their product as it moves through the supply chain. Using new tools and technology, waste can be managed from the field or factory to the customer.

To truly measure a products condition though the supply cold chain direct biological and chemical measurements of the “fingerprints” of decay and contamination are required. For economic reasons direct biological and chemical measurements of these “fingerprints” are simply not possible due to sensor costs. While the most accurate, conventional laboratory analysis using manual lot sampling is skilled labor intensive, has very high equipment costs, the slowest time to answer and is simply too expensive.

### STATE OF THE ART

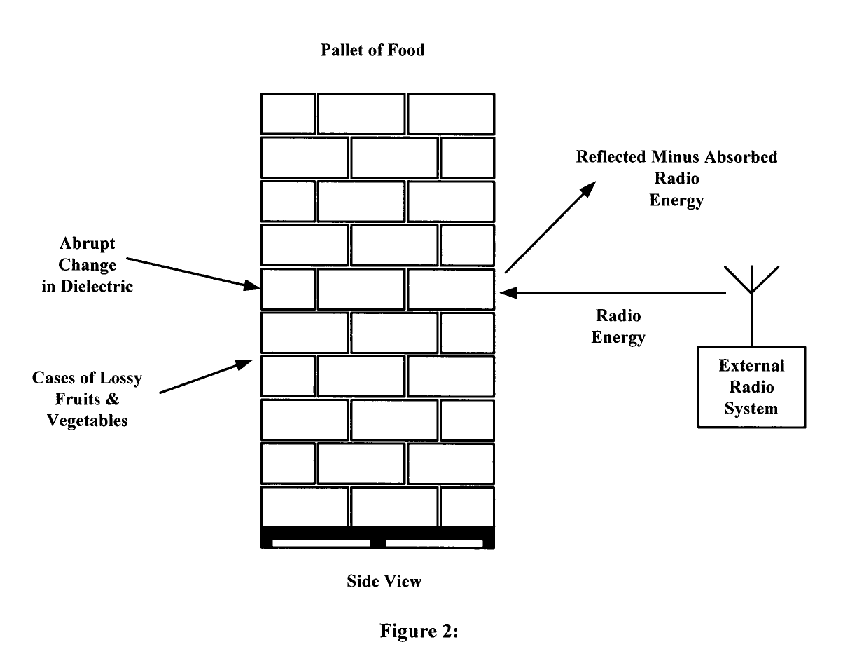

RFID technology in comparison to barcodes in terms of memory capacity, readability, speed, being re-programmable, robustness and scalability is vastly superior, but conventional RFID does not penetrate water based fruits, vegetables or meats very well because these materials are a lossy dielectric and present an abrupt dielectric shift to impinging radio waves, FIG. 2.

Currently the aim of all existing approaches is focused on implementing the EPC Global Tag Data Standard (TDS) into sensor RFID tags, which have the same capabilities as the conventional RFID technology is already providing for other product types. At the Carton and items levels, conventional RFID and RFID concepts cannot work for produce, ever. The reason for this is simple; conventional RFID is about single pass read speed and accuracy, the chemical measurements take too much time. (This is due to chemical ionic transfer processes not electronic transfer processes so the time scales are six orders of magnitude slower).

Carton and Item level tagging is desired because it allows much higher granularity of the Chemical and Biological measurements (e.g. it allows measurement at the individual Package level rather than the Pallet level in current devices. In recognition of this problem in the “Cold Chain”, current RFID solutions providers are driving the current market push. However, current RFID Technology has reached technological plateau. This is not for lack of trying. This is demonstrated by the introduction of semi-active or Battery Operated Passive, BOP, temperature logging RFID tags as a stopgap.

Other entities realizing this problem have recently introduced semi-active or BOP temperature logging RFID in an attempt to increase granularity. However, because of their cost, the data granularity of these RFID temperature-logging sensors is poor because they can only be fitted to selected areas. Care must be taken in placing these sensors in enough numbers and in locations that are representative of the entire product load. The thermal behavior of transport and storage systems varies significantly depending on the type of product, stowage practices, packaging and many other factors leading to a wide spatial variation of product cargo temperatures. The spatial variation problem has not been solved notwithstanding a great deal of time and money.

A feature of the inventive concept is that it allows much higher granularity of the Chemical and Biological measurements (e.g. it allows measurement at the individual Package level rather than the Pallet or Truck Load level in current devices.

A further problem with both the Active and “Semi-passive” temperature sensing RFID tags is they can only infer the amount biological and chemical decay based on historical data logs. It is obvious direct biological and chemical measurement of the decay process is preferable to any estimate based on temperature history.

Temperature logging is inferior in every respect because it can only estimate based on historical data. Historical data for each product is simply not available so existing devices are currently expending R&D capital to build the required data sets.

Most importantly, while the causes of the spoilage and waste losses are numerous only about half the losses are to variations in temperature. A solution is required to close this gap by providing information about the other half.

There is therefore an opportunity for dramatically increased synergy between electronics and chemistry and biology, fostered by the march of electronics technologies and rapid advances in system, chemistry and biology to reduce waste during shipping.

The key enabling technology linking these two areas is a conversion technology that converts chemical or biological information into electrical signals and providing the ability to collect and analyze essential data on the state of the chemical analyte, biomolecules and cells (chemical, physical, structural, functional) wirelessly.

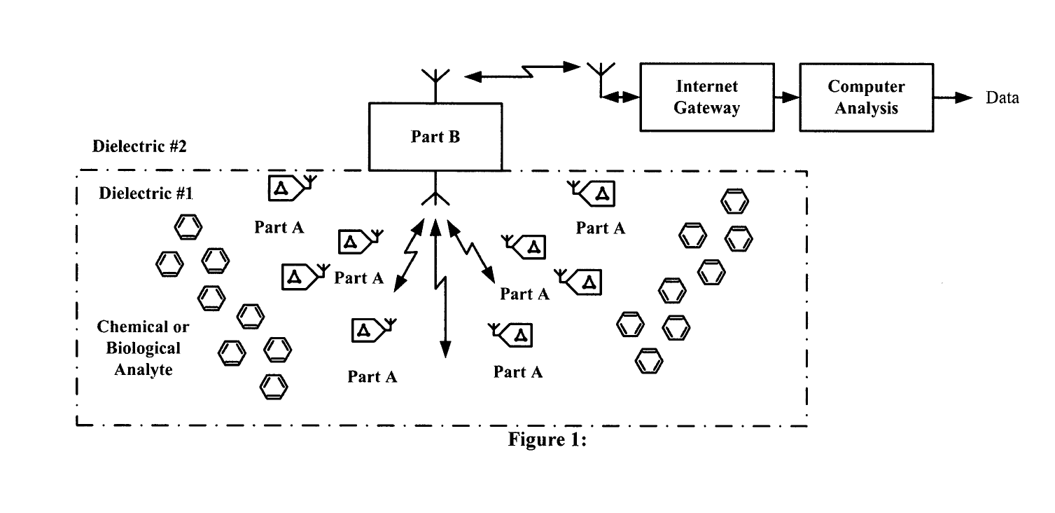

The object of the invention is to provide a solution to food spoilage and waste by providing stakeholders with actionable data about the quality and condition of their product as it moves through the supply chain in order to better manage waste from the field or factory to the customer automatically and wirelessly, FIG. 1.

A further object of the invention is to eliminate electrochemical batteries in contact with a fresh food product as these devices can contaminate the food product.

These objects are achieved by the invention by providing an apparatus, methods and system to enable direct biological, chemical and temperature measurements of the “fingerprints” of decay and contamination to truly measure a products condition though the supply chain. The inventive concept achieves a disposable sensor system at a fraction of their current costs combined with a new circuit and wireless communications techniques to achieve automation combined with accuracy and reliability to provide a chemical or biological sensor system at the carton and item level, which exhibits none of the problems with which prior sensors system are beset.

These objects are further achieved by the invention at economic price points allowing disposability reducing cross contamination at the shipping carton and item level without expensive conventional laboratory analysis using manual lot sampling associated skilled labor, very high equipment costs and slow time to answer.

### SUMMARY OF THE INVENTION

The present invention provides a set of two apparatus for sensing the concentration of a chemical or biological analytes and the chemical or biological analytes temperature, methods for communicating data derived thereof and a system acting as radio frequency identification (RFID) tag, wherein the sensor RFID tags are in direct contact with the analytes to be measured.

The physical wireless layer of the invention takes advantage of the fact that an Electromagnetic, (EM), wave incident on the surface of a dielectric material can either be reflected (i.e. reflected wave) or be transmitted into a material (i.e. transmitted wave). When there is a shift between dielectric properties going from air, (free space), to another material the transmitted wave will be refracted or bent away from its original path. This effect is commonly observed in a glass of water using light, and is known as Snell's Law. The refracted wave is gradually attenuated as it is converted to thermal energy, with exponent proportional to the imaginary components of the dielectric permittivity. All conventional RFID techniques are limited by the abrupt dielectric shift between air and a fresh food product when attempting to transmit a signal from the outside of a pallet of fresh food and penetrate to the inside as illustrated in FIG. 2.

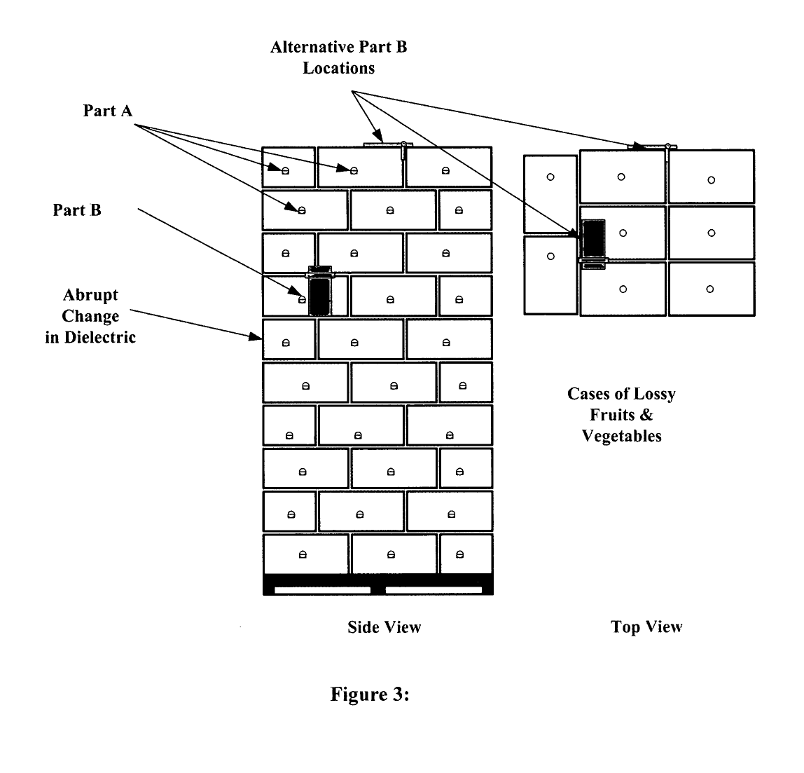

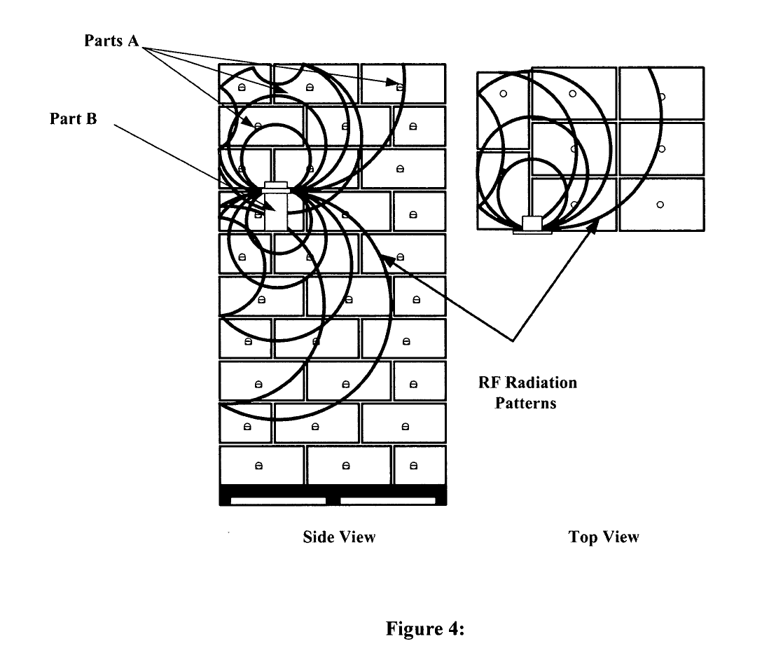

However, if EM waves are introduced inside of a dielectric material with a higher permittivity from a transmitter circuit and there is a sufficient dielectric shift going to another material with a lower permittivity, air for example, the EM waves are internally reflected and bounce back and forth within the higher dielectric materials physical boundaries. FIGS. 3 and 4.

This technique will be recognized to those skilled in the art as commonly employed at microwave frequencies where the dimensions of the dielectric material are controlled a high quality tuned resonator circuit can be created using a RF feed. In addition, if the walls of the dielectric material are partially transparent to EM waves, radio power will radiate outward forming EM radiation patterns that can be constructed to match any conventional resonant wire type or patch antenna.

Those skilled in the art will recognize that utilizing appropriate scaling rules this same technique works equally well for lower frequencies.

The key to the inventive concept is the recognition that a pallet of fresh food can be viewed as a composite RF material and formed into a lossy dielectric resonator rather than a single monolithic block. Of great importance to the invention are the Effective medium approximations or effective medium theory (sometimes abbreviated as EMA or EMT) which pertains to analytical or theoretical modeling that describes the macroscopic properties of composite materials.

In the specific area of fresh food on a pallet an inhomogeneous composite is incidentally created, made up of lossy fruits, vegetables or meat and nearly lossless air surrounding them in the typical packaging carton. To aid cooling of the food during transport the volume fraction in fruits, vegetables or meat packaging is always designed to be 50% so as a composite the effective dielectric losses are always about 60% lower than the individual constituent values of lossy fruits, vegetables or meat. The invention goes a step further placing a third type of inclusion in the form of electromagnetic resonators embedded in the fresh food pallet composite.

Each of the plurality of sensor tag apparatus in the invention contains one of these resonators consisting of an inductive coil and a capacitor. Theoretically it is possible to design these resonators so that at a single frequency the food pallet composite is transparent to EM radiation. However, the invention uses these resonators to both harvest power from the RF feed and communicate with the RF feed circuit. Part of the invention is a method used to “tune” these circuits. Because all RF phase information is lost the inventive method also incorporates the limitation in the communication protocol.

In the invention a part of the sensor tag apparatus is placed inside each carton, case or item as warranted as it is packed and placed on a pallet. The chemical, biological and temperature sensors are in direct contact with the fresh food product and are constructed of materials compatible with fresh food products as illustrated in FIG. 3.

In addition, the housing of the sensor tag apparatus of the inventive concept functions to prevent mechanical crushing forces during shipping, provide a known dielectric in the reactive electromagnetic field of its antenna and maintain correct orientation of the antenna under mechanical vibrations typical of shipping.

It is not desirable for the pallet of fresh food to radiate beyond the pallet because this wastes RF power and can cause interference with other nearby pallets therefore the second apparatus in the invention incorporates an RF feed designed to limit such EM radiation leakage while distributing EM energy as uniformly as possible inside the pallet. The design of this RF feed allows it to be easily relocated to the optimal feed point for a particular pallet configuration and food type.

If a single feed is not sufficient to distribute EM energy as uniformly as required inside the pallet dielectric multiple RF feeds can be added as “clones” of the original.

In the invention, the plurality of sensor tags apparatus can be thought of as a members of a Colony where these sensor tags measure various physical entities as illustrated in FIG. 4.

These Colony Members are connected wirelessly with a single processing function inside a battery operated apparatus acting as a Colony Coordinator equipped with the RF feed device.

At least one Colony Coordinator apparatus is required per pallet but any number can be used to achieve complete EM coverage of the pallet.

The Colony Member apparatus cannot function without a Colony Coordinator because they have no internal energy source.

The Colony Coordinator is also equipped with a second antenna used to relay stored sensor data from Colony Members to the internet cloud using high-speed standard RF signals on demand as illustrated in FIG. 1.

In principle, the Colony Coordinator could query Colony Member tags individually using any of the well-established protocols. However, implementing these protocols is not feasible since the sensor tags apparatus need to be simple for low cost allowing disposability. This communication protocol is specifically designed to match chemical processes rates of change.

Unlike conventional RFID which uses TDMA and complex tag arbitration logic the inventive method uses a much simpler version of Code Division Multiple Access, CDMA, to communicate from the many Colony Member tags located inside each carton to a single Colony Coordinator mounted to the pallet as shown in FIG. 3.

Unlike conventional RFID the inventive method is designed to use no on tag arbitration in order to simplify the Colony Member tags apparatus for low costs allowing disposability.

The Colony Coordinator is programmed with each Colony Member's ID number as part of a binding operation when the pallet is originally built up. The Colony Member ID is used to create a code where the inverse of the received data it is an encrypted image of the ID number. Only Colony Members with a sensed value exceeding a reference value transmitted by Colony Coordinator reply with the encoded ID number, not the measured value itself. The RF signal from each Colony Member is summed in the RF channel with the other replying members. In the Colony Coordinator this sum is despread in a mathematical operation with a processor using the known Colony Member's ID number to produce a set of probabilities of which Colony Members are in fact replying. This set of probabilities is correlated with the reference values so that a sensor bit weight can be assigned to the set of Colony Members under the control of the Colony Coordinator. The sensed bit weight is stored in memory as a “virtual tag” per that Colony Members ID number.

In the Method the reference values can be changed in successive interrogation rounds in order to form a successive approximation analog to digital converter. This technique works because the input data is very slow matching chemical processes. It has the advantages that the BER is excellent in AGWN & IN, is power efficient and has built-in encryption. The converter resolution is variable and the weighted ensemble is very accurate and also Coherent due to the a priori knowledge of the reference values, ID numbers and encoding values, as well as Stochastic due to the nature of the processes themselves.

It is important to note the exact value from each measurement is not recovered using this method, rather a statistically related data set for each measurement value is recovered. This is the underlying principal with all CDMA techniques. Because the sensor data value being measured is relatively static, over many samples a very high precision measurement will converge close to the true sensor value for relay to the downstream analytics software.

The data obtained from thousands of Colony Member tags are harvested by the Colony Coordinators and further the data from thousands of Colonies where the System organizes groups of these Colonies each reporting chemical, biological and temperature information into Groups of Colonies where the System decodes the temperature chemical and biological information and processes the information from each Colony Member in a time correlated database to form an electronic digital domain representation of chemical, biological and temperature information for further analysis.

The System also formats the time series database based on the interpreted chemical and biological information for relay back to a decision point thus creating actionable intelligence of decay at the carton and item level.

Thereby using the above, Apparatus, Methods and System collecting data from inside an electrical dielectric medium of interest for the temperature, concentration of a chemical or biological analyte located physically inside each carton or item and relaying this data to external information processes the object of the invention is thus fulfilled.

### DETAILED DESCRIPTION OF THE INVENTION

The present invention is directed to a RFID tag apparatus, a method, and a system providing a set of two apparatus, a Part A and Part B for sensing the concentration of a chemical or biological analytes and the chemical or biological analytes temperature, methods for communicating data derived thereof and a system acting as radio frequency identification (RFID) tag, wherein the RFID tag is in direct contact with the analytes to be measured.

A more complete understanding of the colony of RFID tags having a Chemical, Biological and temperature sensing tag will be afforded to those skilled in the art, as well as a realization of additional advantages and objects thereof, by a consideration of the following detailed description of the preferred embodiment.

In accordance with an embodiment of the invention, there is provided an individual radio frequency identification (RFID) tag for sensing either one or a plurality of a concentration or other such data deemed appropriate of a chemical or biological analytes and the chemical or biological analytes temperature with an identifier and communicating data derived thereof acting as a member of a colony of radio frequency identification (RFID) tags, wherein the individual RFID tag is in direct contact with the chemical analyte and a means for transmitting chemical, biological and temperature data.

The radio frequency identification (RFID) apparatus made up of two parts, wherein a plurality of first named Part A incorporate temperature and chemical sensors immersed in a liquid analytes, gaseous analytes or combination thereof in an electrical dielectric medium of interest communicate using radio waves to at least one second named Part B located on the boundary of and perhaps, extending into the dielectric containing liquid analytes, gaseous analytes or combination thereof at the boundary of the electrical dielectric mediums of interest.

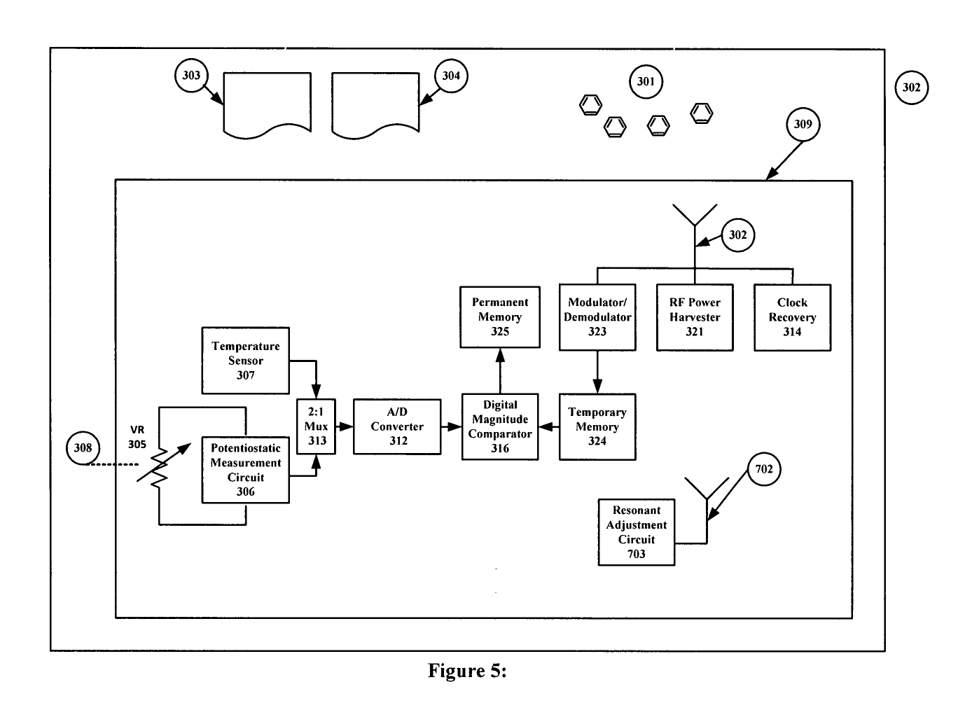

Referencing now FIG. 5, the Part A apparatus comprises: a liquid analytes or gaseous analyte s 301 or combination thereof in an electrical dielectric medium of interest; at least one antenna in the form of an electrically small magnetic dipole 302; a removable label 303; a fixed label 304; at least one first sensor comprising an area of a reversible chemoresistive surface VR 305 coupled to a potentiostatic measurement circuit 306 at least one second sensor similar to the above coupled in order to sense temperature 307; a mechanism for delivering gaseous or a liquid analytes to the said area 308; a set of connections providing for the formation in the structure of layers of conducting material comprising a circuit; a housing providing a known dielectric medium around the antenna said housing designed with features maintaining alignment under mechanical vibration 309; additional circuits acting as at least one analog to digital converter s 312, as a clock recovery mechanism 314, an electrical energy harvesting mechanism from rectified RF energy 321, acting as a modulator for RF modulation and as an envelope detector demodulator suitable for off-on-keying, (OOK) or amplitude shift keying, (ASK) modulation acting as a receiver for a reference value, commands and other signals as required 323, a circuit acting as a digital magnitude comparator 316, a circuit temporally holding digital data 324 were said data is a reference value and command and temporally holding digital data were said data is a measurement value; a circuit permanently holding digital data 325 were said data is an identification value said code value references said label and permanently holding digital data were said data is an encoding value; and a circuit temporally holding digital data were said data is a measurement value; and may, perhaps include additional variable capacitors 703 and least one second electrically small antenna in the form of a magnetic dipole inductively coupled to the first electrically small antenna 702.

The apparatus may, possibly operate in a gaseous medium, or in a liquid medium isolated by a protective housing creating an air space around the antenna 309.

The apparatus may, possibly be protected from mechanical crushing forces by a protective housing creating an air space around the antenna 309.

The apparatus may, possibly incorporate features that maintain optimum orientation from mechanical vibrational forces by a protective housing creating an air space around the antenna 309.

The circuit may, possibly contain a silicon microchip and the sensor is configured to sense a specific analytes concentration or other such data deemed appropriate.

The electrically small magnetic dipole antenna 302 is configured to receive RF energy and to transmit the energy simultaneously wherein the signal is an electromagnetic radio frequency signal.

The first electrical dielectric medium of interest 301 has an electromagnetic wave number greater than or equal to three times said second dielectric medium of interest 302. Under this condition the step change in the dielectric causes the electromagnetic wave inside the first dielectric medium 301 to be reflected back into the first dielectric medium 301. It is important to note that this mechanism causes severe phase distortion of the electromagnetic signal and it is for this reason many of the features of the invention will be apparent to those skilled in the art exist and are different than conventional radio practice.

Also note this apparatus, Part A, does not contain a battery or conventional oscillator circuit both to lower costs and prevent contamination of food products.

The sensor is created using a chemoresistive surface 305 and is configured to sense a specific analytes concentration or other such data deemed appropriate.

Wireless operation is provided using the clock recovery circuit 314 which recovers clock information modulated on a RF signal, and also receives commands modulated on a RF signal from and only from Apparatus Part B described below. On command this circuit acts on the combination of recovered clock information and commands to initiate and perform analog to digital conversion on a voltage signal generated from the potentiostatic measurement circuit 306 sensing a specific analytes concentration, temperature or other such data deemed appropriate.

The potentiostatic measurement circuit 306 can be replaced with a suitable galvanometric measurement circuit.

The digital output value from the A/D circuit 312, is digitally magnitude compared to a digital reference value temporarily stored in the temporary memory circuit 324, from the commands noted above and if the output of the digital magnitude comparator is logically TRUE the data from the circuit permanently holding digital data 325 is read out in a bitwise manner to said RF modulator structure or if logically FALSE no digital data is read out.

The above digital data stored in 325 consists of a unique identification code value, in the preferred embodiment, 24 bits, encoded with code value that is a known orthogonal code or “gold” code at the time of manufacture. For security reasons, the size of the “gold” and the gearing ratio or modulo is variable providing an encryption mechanism where the encoding operation is accomplished using a logical Exclusive OR function though other functions can be used and is not reprogrammable in the field.

The output from the digital data stored in 325 is used to drive a modulator thus creating RF modulation in an amplitude-shift keying or off-on-keying modulated signal representing the encoded digital representation of the identification code value where the identification code value references the printed label and to transmits the modulated signal using the antenna

In the invention the antenna acts as an electromagnetic RF summing device combining each tags unique RF modulation with a plurality of other similarly uniquely encoded tags RF modulation in supposition or summing as a response signal in electromagnetic space.

Note tags transmit only if the measurement value exceeds the commanded reference value, though obviously the apparatus can be designed to transmit only if the measurement value is less than the commanded reference value, logically the two operations are the same.

An identical operation is carried out for measuring temperature and switched using the two-to-one multiplexer 313 when commanded. All other functions remain the same.

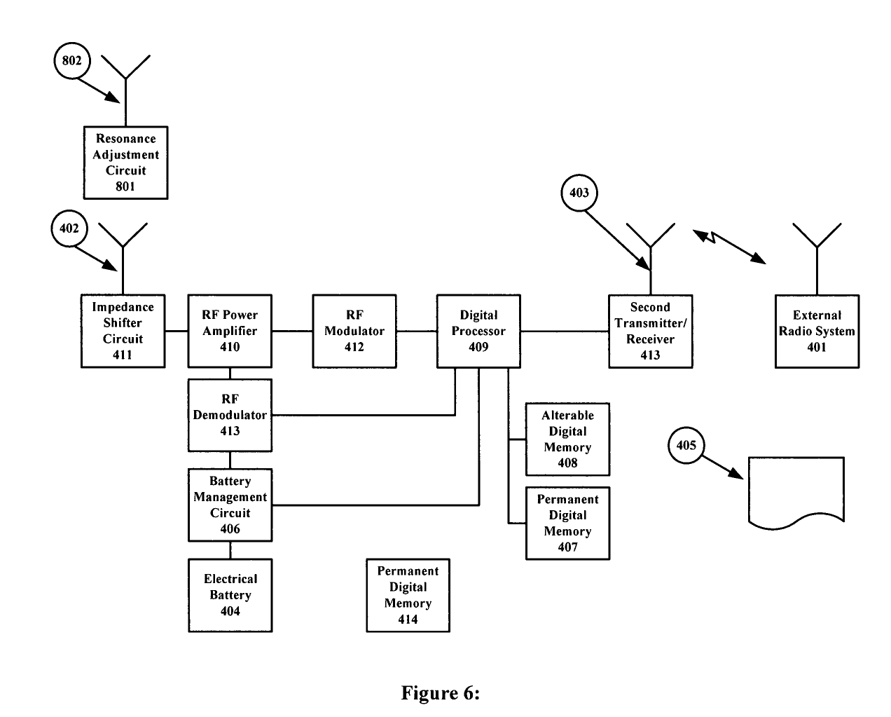

Referencing now FIG. 6, the Part B apparatus comprises: an external radio system 401; a first antenna tuned to radio frequencies of said apparatus first part in the form of a feed suitable for exciting an electrically dielectric resonant structure 402; a second antenna tuned to the external radio systems frequencies 403; an electrical battery 404; a fixed label 405; a set of connections providing for the formation in the structure of layers of conducting material comprising a circuit; a circuit for power management from said battery 406; a circuit comprising permanent digital memory 407; a circuit comprising alterable digital memory 408; a circuit comprising a digital processor 409; a circuit comprising a radio frequency power amplifier connected to said first antenna tuned to radio frequencies of said apparatus first part connected to said feed suitable for exciting an electrically dielectric resonant structure 410; a circuit comprising a circuit to alter the impedance of the antenna tuned to radio frequencies of said apparatus first part connected to said feed suitable for exciting an electrically dielectric resonant structure 411; a circuit 412 acting as a modulator for off-on-keying, (OOK) or amplitude shift keying, (ASK) modulation acting as a transmitter for a reference value, command and clock; a circuit 413 acting as an envelope detector demodulator for off-on-keying, (OOK) or amplitude shift keying, (ASK) modulation acting as a receiver for encoded RF inductive coupling modulation in supposition or summing as a response signal from a plurality of said apparatus first part; a circuit 414 comprising a transmitter and receiver tuned to the external radio systems frequencies; an indicator light and may, perhaps include an resonance adjustment circuit 801 and second electrically small antenna in the form of a magnetic dipole inductively coupled to the first electrically small antenna 802.

The Part B apparatus is located on the boundary of first electrical dielectric medium of interest 301 where a) this dielectric medium has an electromagnetic wave number greater than or equal to three times the second dielectric medium of interest 302 and b) there is no conductive surface at this boundary.

The Part B apparatus uses an antenna 402 as a feed. Mechanically this antenna slips in between individual boxes on a pallet in the preferred embodiment. Antenna 402 takes the form of an electrically small magnetic dipole tuned to radio frequencies of the apparatus part A where this feed excites an electrically dielectric resonant structure formed by the conditions noted above.

This feed 402 is designed to be relocatable to accommodate differing pallet configurations with different dielectric properties.

To those skilled in the art it is apparent in cases where the dielectric medium 301 has an electromagnetic wave number less than three times the second dielectric medium of interest 302 a conductive surface at this boundary must be provided to ensure proper operation.

The operation of the Part B apparatus circuit, FIG. 6 is as follows.

The circuit structure comprises a radio frequency power amplifier connected to the first antenna 402 tuned to radio frequencies of the apparatus Part A exciting the electrically dielectric resonant structure. This circuit comprising a radio frequency power amplifier 410, the resonant structure described above and plurality of antennas 302 and RF power harvesters 321 provides electrical power to the plurality of the Apparatus Part A.

The circuit combines a radio frequency transmitter acting as a modulator 412 for off-on-keying, (OOK) or amplitude shift keying, (ASK) modulation acting as a transmitter for a reference value, command and clock. This circuit comprising the modulator 412, a radio frequency power amplifier 410, the resonant structure described above and plurality of antennas 302 and clock recovery circuits 314 provides reference values, control signals and clock signals to the plurality of the Apparatus Part A FIG. 5.

In the receive mode a circuit comprising a radio frequency receiver 413 alternatively acts as an demodulator for off-on-keying, (OOK) or amplitude shift keying, (ASK) modulation acting as a receiver encoded RF modulation in supposition or summing as a response signal from a plurality of Apparatus Part A.

The circuit comprising permanent digital memory 407, alterable digital memory 408 and digital processor 409 is configured to perform a mathematical despreading operation on received encoded RF modulation from 413 in supposition or summing as a response signal from all transmitting Apparatus Part A. The output of this despreading operation using the a priori stored identification values and encoding code is configured to place the results of the despreading operation combined with a bit weight established by the transmitted reference value into memory corresponding to address locations corresponding to priori stored identification values of the priori stored identification values.

The individual information is filtered and decimated using the digital processor whereby the digital representation of concentration of a chemical or biological analyte acting on the chemoresistive surface of each of Apparatus Part A. Since the reference value and thus the bit weight can, perhaps, be varied in subsequent operations a complete image of the of concentration of a chemical or biological analyte can be obtained in the manner of a successive approximation converter and stored said in memory.

When the circuit comprising said second antenna 403 tuned to the external radio frequencies receives signals from the external radio system 401 the circuit comprising a transmitter and receiver circuit 413 the circuit comprising the permanent digital memory 407, alterable digital memory 408 and digital processor 409 receives an external command from 401 to transmit the set of information from memory corresponding to address locations corresponding to priori stored identification values of Apparatus Part A.

In addition, a visual indicator 414 can be triggered by either the external radio system 401 and receiver circuit 413 or digital processor 409 upon external or internal command.

Thereby using the above, information in memory of the Apparatus Part B is transmitted to outside processes upon demand over the external radio link 401 radio link where each set of information concentration of a chemical or biological analyte information, combined with a unique code value to uniquely identify said information from each of the plurality of Apparatus Part A thereby collecting and providing the temperature, concentration of a chemical or biological analyte data physically inside each carton or item and relaying this data to external information processes inside an electrical dielectric medium of interest thus fulfilling an object of the invention.

A First Method for controlling, clocking and synchronizing a number of sensing RFID tags forming a colony inside an electrical dielectric medium of interest for the purpose of communicating data derived thereof acting as radio frequency identification (RFID) tag said method comprising:
a plurality of first radio frequency identification (RFID) tag apparatus of part A as described above as Colony Members;
at least one of second radio frequency identification (RFID) tag apparatus of part B as described above as Colony Coordinator;

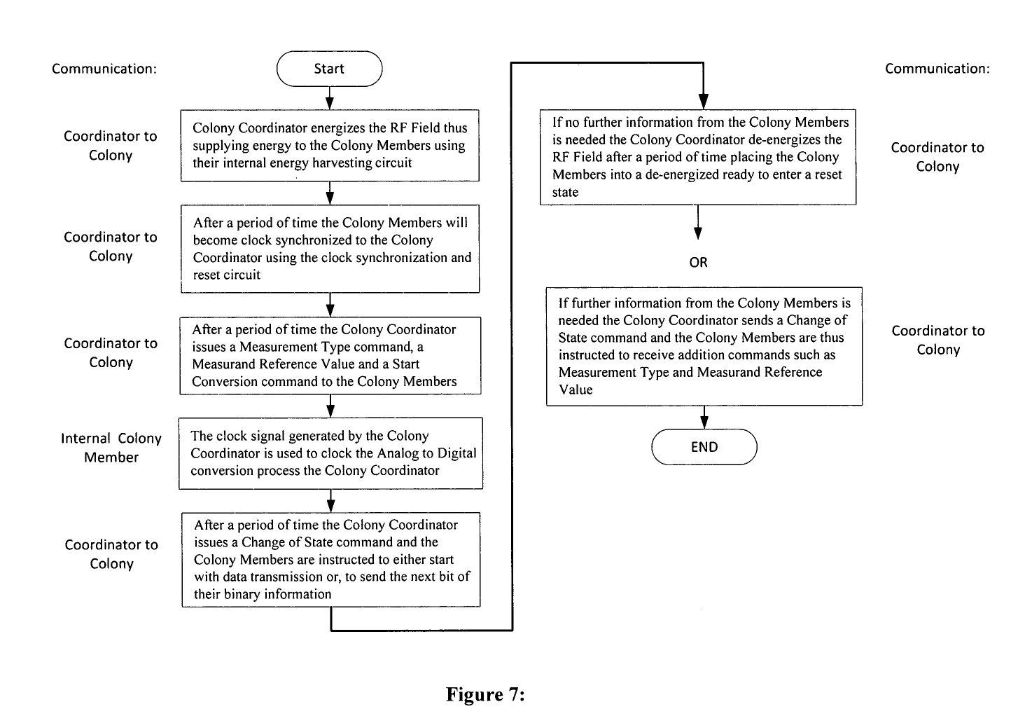

The First Method, see FIG. 7 for reference, controls the Colony consisting a plurality of first radio frequency identification (RFID) tag apparatus as Colony Members where the Colony Members are queried simultaneously and the response of the interrogated tags are collectively clock synchronized to at least one Colony Coordinator.

Colony Members are under complete control of the Colony Coordinator so that the First Method of control uses a synchronization method based on switching on/off the electromagnetic RF field of the apparatus of claim a B acting a Colony Coordinator tag that powers the Colony member tags by interrupting the wireless power supply generated by electromagnetic RF field of the Colony Coordinator; or beginning with transmission by transmitting a modulated start bit in a time slot followed by transmitting the subsequently bit stream in regular sized time slots.

The circuit logic in the Colony Members clock & reset circuit is tuned to interpret request orders sent from said Colony Coordinator device based on capacitor discharge behavior and voltage comparator device in the Colony Members.

Parallel to the circuit logic in the Colony Members clock & reset circuit is circuit logic that detects the external clock synchronization request, an internal clock counter in said clock & reset circuit resets the bit index, and start increasing the count when the next intermission is registered so that the Colony Member tag acquires the actual bit position in the bit sequence in addition to the clock detection circuit a using a memory to preserve the bit index. This memory storage device keeps the storage contents even if the colony tag is not powered for a short term.

The Colony Coordinator causes an intermission to signal the next time slot for transmission, there before increasing the bit index an additional memory buffer stores temporarily the current bit index and induces the bit transmission, there after increasing the bit index a delayed rewritten in the bit index buffer thereby providing the required delay for stabilized rewriting.

Thereby the Method queries the Colony Member tags simultaneously and the response of the interrogated Colony Member tags are collectively clock synchronized and data synchronized by the Colony Coordinator.

Since the processes begin measured by the inventive method have very low time scales synchronization of the Colony Members to the Colony Coordinator will occur after a period of time.

After the synchronization period the Colony Coordinator issues commands to all Colony Members at the time, no individual addressing of Colony Members is required.

The Colony Coordinator commands issued to the Colony Members are at a minimum, Measurement Type, (Temperature or Chemical or Biological measurement), Measurand Reference Value, Start Conversion and Change of State from Reception to Transmission. Optionally a third type of command Resonant Frequency Adjustment may, perhaps be issued.

In the normal sequence of events:
a. The Colony Coordinator energizes the RF Field thus supplying energy to the Colony Members using their internal energy harvesting circuit as described above.
b. After a period of time the Colony Members will become clock synchronized to the Colony Coordinator using the clock synchronization and reset circuit as described above.
c. After a period of time the Colony Coordinator issues a Measurement Type command, a Measurand Reference Value and a Start Conversion command to the Colony Members.
d. The clock signal generated by the Colony Coordinator is used to clock the Analog to Digital conversion process the Colony Coordinator
e. After a period of time the Colony Coordinator issues a Change of State command and the Colony Members are instructed to either start with data transmission or, to send the next bit of their binary information.
f. If no further information from the Colony Members is needed the Colony Coordinator de-energizes the RF Field after a period of time placing the Colony Members into a de-energized ready to enter a reset state; or
g. If further information from the Colony Members is needed the Colony Coordinator sends a Change of State command and the Colony Members are thus instructed to receive addition commands such as Measurement Type and Measurand Reference Value.

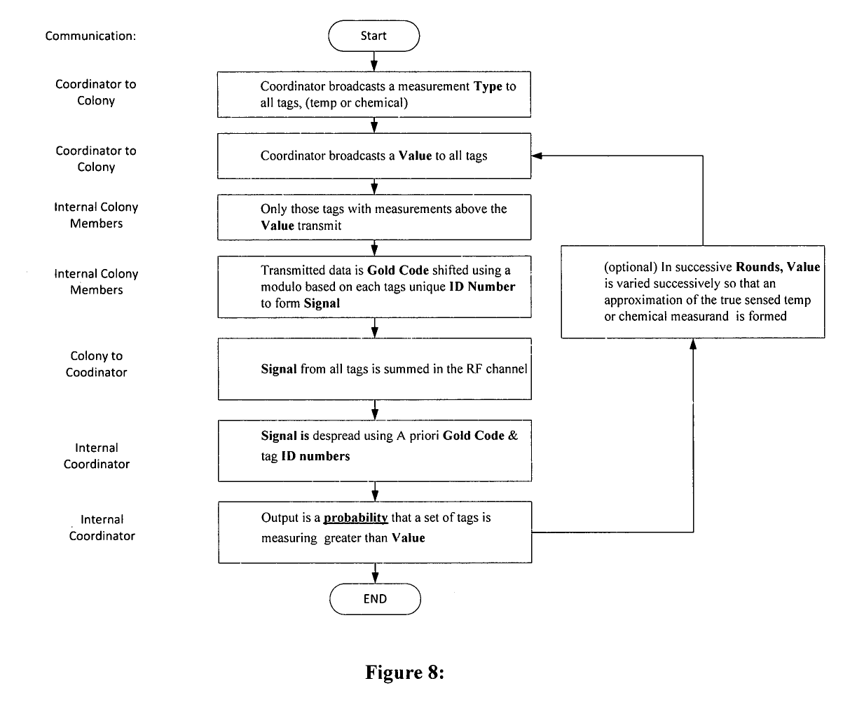

Now referencing FIG. 8, A Second Method in conjunction with the First Method for receiving sensor data from a number of sensing RFID tags forming a colony inside an electrical dielectric medium of interest for the purpose of communicating data derived thereof acting as radio frequency identification (RFID) tag said method comprising:
a plurality of first radio frequency identification (RFID) tag apparatus of part A as described above as Colony Members;
at least one of second radio frequency identification (RFID) tag apparatus of part B as described above as Colony Coordinator;

In the Second Method all Colony Members composed of a plurality of first radio frequency identification (RFID) tag apparatus as noted above response are synchronized into time slots at the current bit index using the First Method as described above and the bit information from all Colony Members composed of a plurality of first radio frequency identification (RFID) tag apparatus as noted above superimposes on the RF channel thereby generating a specific overlaid

All Colony Members are queried simultaneously and the response of the interrogated tags transmit at the same time if and only if the measured value is greater than the reference value transmitted using the First Method by the Colony Coordinator.

In the Second Method Colony Members transmit to the Colony Coordinator using for off-on-keying, (OOK) or amplitude shift keying, (ASK) modulation in supposition or summing as a response signal from a plurality of Colony Members to the Colony Coordinator.

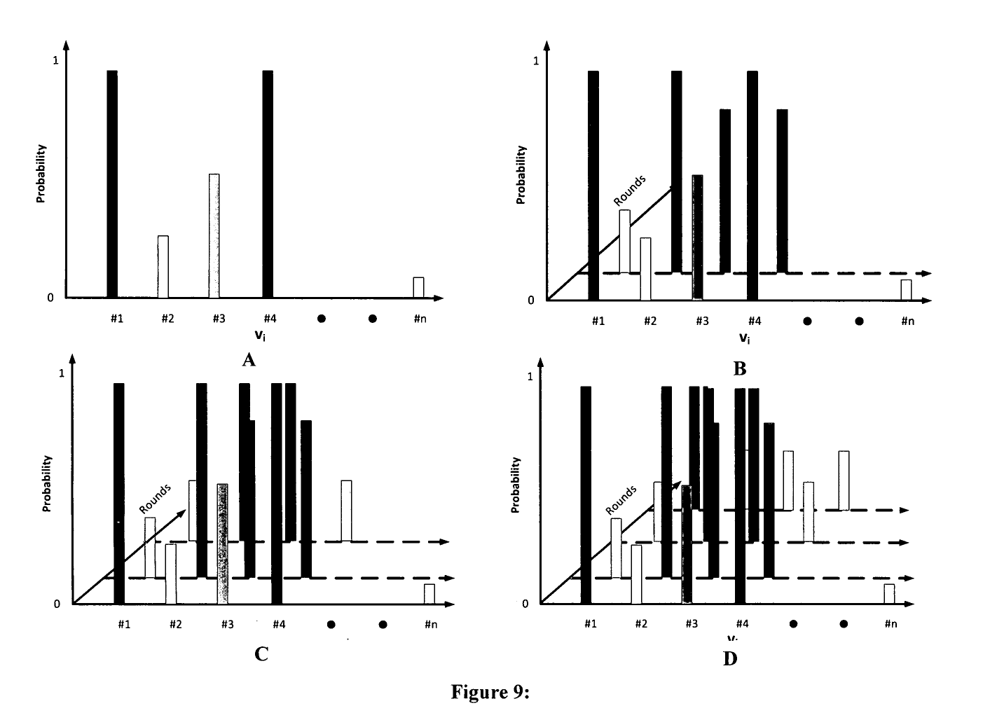

The Colony Coordinator performs a mathematical despreading operation on said received encoded RF modulation in supposition or summing as a response signal from a plurality of Colony Members using both a priori stored identification values and encoding values wherein the following steps are repeated on the plurality of Colony Members;
a) the Colony Coordinator calculates a probability that an individual Colony Member has responded indicating that a particular Colony Member senses a measurement value higher than the reference value transmitted by the Colony Coordinator during the operation of the First Method described above as graphically illustrated in FIG. 9A tags #1 to #n,
b) the Colony Coordinator places the results of the despreading operation into an individual memory location reserved for the specific a priori stored identification value for that specific Colony Member tags #1 to #n,
c) the Colony Coordinator calculates a combined with a bit weight established by the transmitted reference value from the First Method described above and the probability that an individual Colony Member has responded indicating that individual Colony Member senses a measurement value higher than the reference value and places the results of the bit-weight operation into an individual memory location reserved for the specific a priori stored identification value for that specific Colony Member tags #1 to #n,
d) the Colony Coordinator performs filtering and decimation operations on the individual Colony Member combined bit weights in memory whereby the digital representation of said concentration of a chemical or biological analyte acting on the chemoresistive functionalized surface of each sensor or temperature of that specific Colony Member tags #1 to #n,
e) the Colony Coordinator may, perhaps vary the Reference Values using the First Method described above to obtain in the manner of a successive approximation converter a variable resolution ensemble of the digital representation of the concentration of a chemical or biological analyte acting on said functionalized surface of each sensor or temperature of that specific Colony Member tags #1 to #n, wherein said ensemble is stored in memory as graphically illustrated in FIGS. 9 B, C and D.

For Example: as graphically illustrated in FIG. 9 D by applying appropriate bit-weights Tag #1 would read binary 1001, Tag #2 would read binary 0001, Tag #3 would read binary X110, and Tag #4 would read binary 1010 where X denotes an uncertain value.

Thereby the combination of First and Second Method queries the colony of tags simultaneously and the digital representation of a concentration of a chemical or biological analyte acting on said chemoresistive functionalized surface of each sensor or temperature of the interrogated Colony Member tags are collectively obtained and providing the temperature, concentration of a chemical or biological analyte data physically inside each carton or item and relaying this data to external information processes inside an electrical dielectric medium of interest thus fulfilling the object of the invention.

A Third Method for optimizing the resonance of each of the plurality of RFID tag apparatus Part A as described above containing one of these resonators consisting of an inductive coil and a capacitor whereby the resonance point inside an electrical dielectric medium of interest excited by a feed circuit of RFID tag apparatus Part B to optimally harvest power from the RF feed and communicate with the RF feed circuit.

The Third Method consists of two parts.

Part A of the Third Method adjusts the overall resonance of the dielectric resonator by measuring the forward and the reflected RF power delivered by the power amplifier 410 of apparatus Part B connected to RF feed antenna 402 at a given radio frequency. For the forward case, voltage and current samples at the output of the power amplifier 410 are summed to produce a signal that is detected with a diode to give a dc signal that is proportional to the square root of forward power. Because voltage and current are both proportional to the square root of power, so is the sum of RF voltage and current of apparatus Part B connected to RF feed antenna 402 at a given radio frequency.

For the reflected power, a current sample 180° out of phase with the actual current being detected is required. For reflected power, voltage and current are sampled at the Resonant adjustment circuit 801 and antenna 802 electromagnetically coupled to the RF feed antenna 402 and summed to produce a signal that is detected with a diode to give a dc signal that is proportional to the square root of reflected power.

For a given load impedance, the method iteratively changes the electrical characteristics of the resonant adjustment circuit 801 until impedance matching is achieved within a margin of error wherein the voltage and current samples present nearly equal amplitudes at the summation point and are nearly exactly out of phase with each other within a tolerance, giving a very small or zero summation signal. This is also peak-detected to give a dc signal proportional to the square root of reflected power.

It will be appreciated to those skilled in the art that the actual load impedance at power amplifier 410 is the combination of its own impedance, the impedance of the RF feed antenna 402, the combination of the Resonant adjustment circuit 801 and antenna 802 and most importantly the combination of the dielectric resonator formed by the medium of interest and the plurality of RFID tag apparatus Part A located in the dielectric resonator formed by the medium of interest.

Part A of the Third Method iterates until no changes in the ratio of the forward and the reflected RF is achieved.

Subsequently, Part B of the Third Method adjusts the overall resonance of the dielectric resonator by commanding all of RFID tag apparatus Part A to change the resonance created by the combination of the dielectric resonator formed by the medium of interest and the plurality of RFID tag apparatus Part A located in the dielectric resonator formed by the medium of interest using commands received to alter the impedance using a Resonance Adjustment Circuit 703 and antenna 702 electromagnetically coupled to the RF antenna 302 of the RFID tag apparatus Part A.

The Third Method Part B iteratively changes the electrical characteristics of the resonant adjustment circuit 703 and antenna 702 electromagnetically coupled to antenna 302 using commands from RFID tag apparatus Part B until impedance matching is achieved by measuring the forward and the reflected RF power delivered by the power amplifier 410 of apparatus Part B connected to RF feed antenna 402 at a given radio frequency as described above in Part A of the Third Method where by adjustments Resonant adjustment circuit 801 and antenna 802 are not made.

It will be appreciated to those skilled in the art that the actual load impedance at power amplifier 410 is the combination of its own impedance, the impedance of the RF feed antenna 402, the combination of the Resonant adjustment circuit 801 and antenna 802 and most importantly the combination of the dielectric resonator formed by the medium of interest and the plurality of RFID tag apparatus Part A located in the dielectric resonator formed by the medium of interest and the resonant adjustment circuit 703 and antenna 702 electromagnetically coupled to antenna 302.

Part B of the Third Method iterates until no changes in the ratio of the forward and the reflected RF is achieved.

Thereby Parts A and B of the Third Method maximizes the resonance of the dielectric resonator formed by the medium of interest to optimize the power transfer and communications to the plurality of RFID tag apparatus Part A located in the dielectric resonator formed by the medium of interest is achieved.

A System FIG. 1, that whereby organizes a great plurality of first radio frequency identification (RFID) tag apparatus of part A as described above as Colony Members as a subset of a plurality of second radio frequency identification (RFID) tag apparatus of part B as described above as Colony Coordinator as a set utilizing the First Method and Second Method each reporting chemical, biological and temperature information into a colony whereby said System decodes said chemical and biological information and processes said information from each individual Colony Members sensor tags is a member utilizing a known code sequence to form an electronic digital domain representation of said chemical, biological and temperature information. Said System comprising;
a. a plurality of first radio frequency identification (RFID) tag apparatus of part A as described above as Colony Members, and
b. at least one of second radio frequency identification (RFID) tag apparatus of claim 1 Part B;
c. a label reading device connected to a first mobile device apparatus, said device is connected to the internet;
d. an unknown number of other second mobile device and fixed apparatus, said devices are connected to the internet;
e. a computer an analysis element connected to the internet;

The System formats both the set and subsets of decoded chemical and biological information thereof for relay to a gateway element for either immediate or delayed retransmission to the computer analysis element.

The System contains a computer analysis element performing computations on said information to estimate the amount of Chemical and Biological analyte and temperature characteristics sensed by each individual member of each colony.

Said System also organizes an even greater plurality of sensor tags each reporting chemical, biological and temperature information into many colonies whereby said system obtains data from thousands of Colony Member tags thereby harvested by a plurality of Colony Coordinators and further the data from thousands of Colonies whereby the System organizes groups of these Colonies each reporting chemical, biological and temperature information into Groups of Colonies whereby the System decodes the temperature chemical and biological information and processes the information from each of the Colony Member sensor tags in a time correlated database to form an electronic digital domain representation of said chemical, biological and temperature information for further analysis. Said System formats the time series database based on the interpreted chemical and biological information for relay back to a decision point thus creating actionable intelligence of decay at the carton and item level.

In the preferred embodiment the application is toward shipping carton and item level tagging e.g., where a plurality of said Cartons and perhaps, Items are equipped with Colony Members sensor tags apparatus of part A as described above incorporating said Methods combined with a single a single signal processing bridge apparatus of part B managing the colony as Colony Coordinator mounted on a shipping pallet whereby said bridge apparatus of part B decodes and converts said information from the members of the Colony to standard digital formats to both sense and relay said Chemical & Biological decay information at the shipping carton level back to a decision point thus creating actionable intelligence of decay at the carton and item level.

Thereby using the above, Apparatus, Methods and System collecting data from inside an electrical dielectric medium of interest for the temperature, concentration of a chemical or biological analyte located physically inside each carton or item and relaying this data to external information processes the object of the invention is thus fulfilled.

In the Apparatus Part A as described above the potentiostatic measurement circuit 306 can be replaced with a galvanometric measurement circuit.

In the Apparatus Part B as described above the battery 404 and second radio external radio system 413 and antenna 403 tuned to a second radio frequency can be replaced with a wired interface circuit to an external interface.

It will be appreciated to those skilled in the art that if the first electrical dielectric medium of interest has an electromagnetic wave number less than three times the second dielectric medium of interest the inventive System, Methods and apparatus will function as described above if bounded by an electrical conductor.

In a further example embodiment: many commodities can become damaged by water onboard ships holds. This can take many forms but the most common involve either ingress of water from an external source (sea water or rain water) or movement of moisture within the hold leading to cargo damage. Often more than one of these mechanisms may be in place and it becomes important to understand what processes cause which phenomena and which is likely to be more significant for proper remediation.

Grain, fertilizer, coal, and other commodities primarily move around the world in what are called dry bulk vessels. Dry-bulk is a term used to describe ocean going vessels that have 4-9 cargo holds into which coal, ore, metals, fertilizer, and grains can be directly poured into and easily discharged in bulk. These vessels are configured differently than general cargo (tween deck vessels), tanker, liquid bulk, and container ships. The world dry-bulk fleet is comprised of various cargo size vessels. The larger ships, from Suezmax and up, are not typically used to carry grains and oil seeds. The focus of this embodiment will be on agricultural-type commodities such as grain and animal feedstuffs, but some of the principles will apply equally to other cargoes,

In recent years, the United States the world's leading producer and exporter of grains has lost market share to Argentina and Brazil. Even though, U.S. production costs are higher, the total transportation costs from point of production to the ultimate destination in Asia are generally lower than for South America, allowing U.S. grains to compete. However, relatively small differences in seaborne transportation costs can make South America gain exports more competitive than those of the United States, diverting trade from the United States to Brazil or Argentina, and/or the other way around.

An important cost of shipping these cargos are premiums for Ocean Cargo Insurance which is based in history and declared value. Therefore, to maintain a competitive advantage it is of great economic importance to reduce these premiums. When a vessel arrives at discharge, it is commonplace for an inspection to take place of the surface of the stows. If sea water has entered the hold through leaking hatch covers, that should be evident from the surface. It is however often difficult to assess the severity of wetting from the surface. This becomes more apparent later during discharge. In all cases this results in economic loss therefore higher Ocean Cargo Insurance premiums.

It is the focus of this embodiment to configure the apparatus Part A as described above with at least one first sensor comprising an area of a reversible chemoresistive surface VR 305 is made sensitive to moisture and coupled to a potentiostatic measurement circuit 306. The temperature sensor is not changed.

In this embodiment of the invention a plurality of the apparatus Part A as described above is placed inside in the material, for example wheat, as it is packed the hold of the bulk carrier. From a RF perspective the most significant difference from a pallet of fresh food in the preferred embodiment is that instead of relying on the step change in dielectric permittivity from a material with a high permittivity to low permittivity to reflect and distribute EM radiation inside a pallet, a Bulk Carrier carrying wheat has a low dielectric permittivity, wheat, bounded by a good conductor, the steel structure of the ship that none the less can form a resonator possible to excite the resonators used in the Colony Members to both provide power and communicate with the Colony Coordinators, one per hold.

In this embodiment the feed 402 used in the apparatus Part B, Colony Coordinators as described above are used to excite a dielectric resonator formed by the wheat/steel hull combination per hold to reflect and distribute EM radiation inside the hold. In some instances, perhaps, it may be desirable to replace the second radio system 403 and 401 with a wired interface and the battery 406 with ships interfaces and power.

This embodiment can be used to detect condensation (ship's sweat) wetting of bulk cargoes which is essentially a surface phenomenon and rarely penetrates more than a few centimeters into a stow. It happens when the steelwork is cooled by external conditions leading to moisture deposition on the cold steel.

This moisture migration is a more complex phenomenon and is usually caused by temperature differences. Moisture tends to move from warmer cargo into cooler parts of the stow. Large movements of moisture only take place when there are large temperature differences affecting large areas. Usually moisture migration involves moisture being driven upwards in the stow by warm cargo.

It is important therefore to see moisture migration as the consequence of a temperature gradient, not an actual mechanism causing damage in its own right. Many attribute damage associated with caking or moldiness' to “moisture migration” without actually considering what has caused the moisture movement.

In some cases, cargo can become cooled by external conditions, and this may result in moisture migrating to that cooler cargo which then deteriorates. This only affects cargo at or very near the periphery of a stow.

More usually, moisture migration is caused when cargo becomes warmed. This can take place by heat transfer from an external source such as a bunker tank. The amount of bulk cargo which can be damaged by an external heating source tends to be limited and restricted to that adjacent to the source, but there can be some spread of damage away from the immediate area by moisture migration. It is unusual, however, to see this spread far into the stow.

Another possible reason for cargo becoming warm is when it self-heats as a consequence of its inherent moisture and temperature. This can result in large regions of a bulk cargo becoming warm and caked, and large migration of moisture can result from this. This, in turn, will tend to cause condensation and wetting at the surface of the stow, but it is important to note that it is the self heating which started the process and is the underlying cause behind all of the observed deterioration. Self-heating is the fundamental process driving “moisture migration” in nearly all instances.

By embedding the Colony Members in the bulk cargo this embodiment can be used to detect this moisture a shipper will be able to understand exactly what the condition of the bulk cargo is during transit with a granularity not previously possible.

Further, shippers will be able to understand exactly what the condition of the bulk cargo is during transit. Using the system shippers can dynamically match bulk destination and distribution routing with relative shelf life expectancy to ensure delivered product freshness to make meaningful decisions about a particular ship load.

Therefore, an object of the invention using a and moisture and temperature sensor to monitor and report the severity of moisture in bulk cargos such as grains utilizing the System combined with ships wireless reporting network, and possibly, algorithms for processing the signals being output by the sensors, Methods and Apparatus described above thus creating an RFID tag of the type described above used advantageously to make a moisture and temperature detecting solution to reduce Ocean Cargo Insurance Premiums is realized.

In a further example embodiment: while the worldwide pharmaceutical market is in excess of $400 billion, the U.S. pharmaceutical market is valued at greater than $200 billion and includes about 14,000 drugs. To reduce the costs of producing these drugs, U.S. manufacturers are going abroad. However, this raises counterfeit concerns. According to Physician's News Digest, “as drug manufacturers have moved their production plants worldwide, some countries like Pakistan, India, Thailand and Mexico have become havens for the production of unapproved, knock-off drugs.”

About 32 drugs are the most commonly counterfeited and or adulterated due to their high dollar value and physical characteristics. Because many of these pharmaceuticals come in liquid form, counterfeiters can easily dilute them with water.

This is a chemical problem requiring a chemical anti-counterfeiting solution to secure the chain of custody per the Prescription Drug Marketing Act (PDMA) to maintain product ‘pedigrees’.

In this example embodiment the system, method and apparatus described above is combined an algorithm using the temperature dependence of reaction rates to detect counterfeiting and adulteration. In the embodiment, a set of 16 different inert carrier tagging solutions are available that slowly decay over time into measurable but safe reaction products. Zero to four from this set of tagging solutions are included in the drug at varying starting concentration or other such data deemed appropriates to introduce uncertainty for the counterfeiter. The method and apparatus described above is included inside the package in contact with the drug at the time that the drug is first packaged. The method and apparatus described above has a unique identification number, temperature-sensing element with temperature logging memory and a four Measurand chemical sensor tailored to the specific tagging solutions employed.

At any impact point in the delivery chain the method and apparatus described above can be read using mobile readers and the results linked back to a cloud based Anti-Counterfeiting Analyzer platform. The cloud based Anti-Counterfeiting Analyzer platform compares the encrypted ID number that is referenced back to the specific tagging solution set and starting concentration or other such data deemed appropriates, the time and the temperature log to form an mathematical inverse estimate of the expected decay products based on the algorithm. If this estimate is in variance with measured data and it's history the product will be flagged and these results communicated to the impact point in the supply chain for action.

The drug production plants are blind to the exact inert carrier tagging solutions and concentration or other such data deemed appropriates actually employed on a lot-by-lot basis eliminating production plant shrinkage. The introduction point of an adulterant can be determined by reverse tracing the steps of supply chain.

This technology is automatic and is much less costly than lot sampling using expensive lab instruments and skilled labor. The tags can be made at a price point allowing disposable tags. Many current and costly detection processes could be refined or even discarded though the use of the invention at the point of impact to maintain product ‘pedigrees’.

The system has deliberate blind spots built in for security. In the envisioned Concept of Operation, ConOps, tags using the method and apparatus described above the will interact with a smart phone app though a common carrier onto the internet. The interrogator or smart phone app are blind to what is being sensed.

The ID number, the raw sensed analyte and time stamp data will be transmitted over these links to a secure List Server that cross reference the ID number and forward the identity of the chemical and starting concentration or other such data deemed appropriate used in that tag to another secure Analyzing Server. The List Server is also blind to what is being sensed.

The Analyzing Server applies the algorithm with the time stamp and actual identity of the chemical and starting concentration or other such data deemed appropriate to determine the tags current values that are compared to the tags supply chain history to authenticate the tag. The Analyzing Server then forwards the status authentication status to an Authentication Server for action. The Analyzing Server is blind to what action if any is performed by the Authentication Server.

It is not our place to tell the Drug manufacturer what to do with this information at this point, though the Authentication Server could alert the smart phone app if desired.

Therefore an object of the invention using a chemical anti-counterfeiting solution to secure the chain of custody per the Prescription Drug Marketing Act (PDMA) to maintain product ‘pedigrees’ utilizing the system, method and apparatus described above combined an algorithm using the temperature dependence of reaction rates to detect counterfeiting and adulteration, creating an RFID tag of the type described above used advantageously to make a chemical anti-counterfeiting solution to secure the chain of custody by sensors (each carrying a selective area toward a different chemical species) combined into a wireless sensor grouped on an isolating housing provided with an appropriate wireless network, and possibly, circuitry and devices for processing the signals being output by the sensors is realized.

In yet another example embodiment, the FDA is overhauling the food safety system, and companies impacted by the FSMA ruling will be forced to abide by these eventual new regulations. At this time, it is still unknown how soon shippers, drivers, carriers, and receivers of food products must comply. The FDA may seemingly be dragging its feet with regard to the proposed FSMA ruling, since it is immersed in a large undertaking. In spite of the fact that additional time is needed to initiate this enormous ruling, the department is fully intent on enforcing these sanitary and food safety rules in 2015 and early 2016. The FDA is already focusing inspections on companies that deal in food handling, storage, shipping, and sanitation. It will target certain processes within a facility that are most likely to be vulnerable, rather than targeting specific foods or hazards. From the FDA analysis:¹ ¹ Docket No. FDA-2013-N-1425

The Intentional Adulteration Group was a ‘subset’ of the 14,000 companies impacted, and it was comprised of 4,624 companies. This number was calculated by conducting an impact analysis using economics based upon companies doing more than 10 million annually in sales. The analysis was taken using SIC codes and Dunn and Bradstreet reports.

In essence, there will be an expectation placed upon every vendor, shipper, supplier, and receiver of foods to comply with these standards. Companies will need to be ready with records to verify they are in compliance. Facilities will sometimes be required to provide this proof within 24 hours. In the context of ‘preventable control,’ the FSMA ruling gives the FDA legal authority to access records, determine reasonable belief the food might be adulterated, and allow 3rd parties to help enforce these rules.

Therefore, an object of the invention advantageously using the utilizing the system, method and apparatus described above designed to target the specific food product itself using the temperature dependence of reaction rates and history to detect spoilage, creating an RFID tag of the type described above using advantageously RF technology, wherein several sensors (each carrying a selective area toward a different chemical species) combined into a wireless sensor grouped on an isolating housing and orientation provided with an appropriate wireless network, and possibly, circuitry and devices for processing the signals being output by the sensors is realized.

In a still further example embodiment: falsified medicines are a growing risk worldwide. Twenty-four percent of counterfeit products seized at EU borders are medications. To keep them out of the legal distribution chain in Germany, pharmaceutical manufacturers and wholesalers as well as pharmacists in Germany are joining forces to offer a better means of preventing falsified medicines from being handed out—by developing a security system that will be able to test whether medicinal products are genuine. The securPharm initiative launched by their associations will elaborate this system and test it in a pilot in 2013. The system is intended to comply with the EU's new stipulations for preventing counterfeits and—after wide-scale rollout—ensure that patients still have a safe source for their medicines at all times.

Medications that may have been falsified must therefore be furnished with a security feature that can be used to check the authenticity of the medication at any time along the entire supply chain from when it leaves the production facility right through until it is dispensed to the end user. 750 million packages of prescription medications are dispensed every year in Germany alone.

Currently securPharm has developed a special coding system for Germany based on Data Matrix codes in order to continue to guarantee a high level of security in view of the increasing level of counterfeiting around the globe in order to maintain the legal supply chain from the manufacturer to the wholesaler to the pharmacy. In this technology the product and serial number is displayed on the packaging of the medication. This code can be used to verify authenticity at every point along the legal supply chain. According to the end-to-end approach, verification must be carried out in a pharmacy before the medication is dispensed.

Weakness; securPharm only tracks the pharma package not the pharma itself so it is still vulnerable to tampering including theft, shrinkage, (reducing the amount of pharma in the package), and replacement with counterfeits and adulteration for sale outside of the EU.

In this embodiment the method and apparatus described above is included inside the package combined with a known gas sealed inside the package at the time that the drug is first packaged.

The System Method and Apparatus described above has a unique identification number, may possibly, include a temperature-sensing element with temperature logging memory and a single measurand chemical sensor tailored to the specific gas employed. The pharma packaging is designed to release the gas if the packaging is tampered with thereby becoming diluted with room air.

At any impact point in the delivery chain the method and apparatus described above can be read using RF readers to detect the introduction of room air. If room air is detected, the product will be flagged and these results communicated to the impact point in the supply chain for action.

The introduction point of tampering can be determined by reverse tracing the steps of supply chain.

This technology is automatic and is much more effective than a simple bar code in detecting theft, shrinkage, (reducing the amount of pharma in the package), replacement with counterfeits and adulteration. The tags can be made at a price point allowing disposable tags. Many current and costly detection processes could be refined or even discarded though the use of the invention at the point of impact to maintain product ‘pedigrees’.

It is not our place to tell the Drug manufacturer what to do with this information at this point, though the system could alert the smart phone app if desired.

Therefore, a further object of the invention for the detection of tampering to maintain product ‘pedigrees’ utilizing the system methods and apparatus described above to detect the introduction of room air, creating an RFID tag of the type described above used advantageously to make a chemical anti-counterfeiting solution to secure the chain of custody by sensors (each carrying a selective area toward a different chemical species) combined into a wireless sensor grouped on an isolating housing provided with an appropriate wireless network, and possibly, circuitry and devices for processing the signals being output by the sensors is realized.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

Having thus described a preferred embodiment and other embodiments of an Apparatus, Method s and System for sensing Chemical and Biological information and converting said information into the electronic digital domain for relay in a radio frequency identification (RFID) tag embedded in a dielectric medium it should be apparent to those skilled in the art that certain advantages of the invention have been achieved. It should also be appreciated that various modifications, adaptations, and alternative embodiments thereof may be made within the scope and spirit of the present invention. The invention is further defined by the following claims.

1. A radio frequency identification (RFID) apparatus made up of two parts, wherein a plurality of first named Part A incorporate temperature and chemical sensors immersed in a liquid analytes, gaseous analytes or combination thereof in a first electrical dielectric medium of interest communicate to and harvest electrical energy from at least one second named Part B located at a dielectric boundary of said first electrical dielectric medium of interest and second electrical dielectric medium of interest providing communications to external systems and electrical energy for said chemical and temperature sensors using radio waves said apparatus comprising:
A) said apparatus first part comprising;
a liquid analytes, gaseous analytes or combination thereof in a first electrical dielectric medium of interest;
a second electrical dielectric medium of interest;
at least one electrically small antenna in the form of a magnetic dipole;
a removable label;
a fixed label;
at least one first sensor comprising an area of a reversible chemoresistive surface coupled to a potentiostatic measurement circuit;
at least one second sensor similar to the above coupled in order to sense temperature;
a mechanism for delivering gaseous or a liquid analytes to the said area;
a set of connections providing for the formation in the structure of layers of conducting material comprising a circuit;
a housing providing a known dielectric medium around the antenna said housing designed with features maintaining alignment under mechanical vibration;
additional structures acting as at least one analog to digital converter s;
additional structures acting as a clock recovery mechanism;
additional structures acting as an electrical energy harvesting mechanism from rectified RF energy;
a circuit structure for biasing said reversible chemoresistive surface;
a circuit structure acting as a modulator for RF modulation;
a circuit structure acting as an envelope detector demodulator suitable for off-on-keying, (OOK) or amplitude shift keying, (ASK) modulation acting as a receiver for a reference value, commands and other signals as required;
a circuit structure temporally holding digital data were said data is a reference value, commands and other signals as required;
a circuit structure permanently holding digital data were said data is an identification value encoded with a code value references said label;
a circuit structure acting as a digital magnitude comparator;
wherein said first electrical dielectric medium of interest has an electromagnetic wave number greater than or equal to three times said second dielectric medium of interest, and
wherein the circuit structures may, possibly contain silicon microchips, and
wherein the said chemoresistive surface is configured to sense a specific analytes concentration or other such data deemed appropriate, and
wherein the antenna is configured to receive RF energy and to transmit the energy simultaneously, and
wherein the signal is an electromagnetic radio frequency signal, and
wherein the clock recovery mechanism recovers clock information modulated on a RF signal, and
wherein the clock recovery mechanism recovers commands modulated on a RF signal, and
wherein the circuit structure acts on the combination of recovered clock information and commands to perform analog to digital conversion from a signal generated from said potentiostatic measurement circuit sensing a specific analytes concentration, temperature or other such data deemed appropriate, and
wherein the value obtained from the analog to digital converters is digitally magnitude compared to a reference value temporarily stored in said temporary memory structure, and
wherein if the output of the digital magnitude comparator is TRUE the data from the circuit structure permanently holding digital data were said data is an identification code value encoded with code value references said label is read out in a bitwise manner to said RF modulator structure or if FALSE no digital data is read out, and
wherein said output drives a modulator thus converting the RF modulation to an amplitude-shift keying or off-on-keying using load modulation signal representing the encoded digital representation of the identification code value said identification code value references said label and to transmit said modulated signal to said antenna, and
wherein the antenna is configured to combine the RF modulation with a plurality of other similarly encoded RF modulation in supposition or summing as a response signal in space of the amplitude-shift keyed signal or off-on-keying representing the encoded digital value of the identification code value said identification code value references said label only if the sensed magnitude of the chemical or temperature is greater that the received reference value:
B) said apparatus second part comprising;
a liquid analytes, gaseous analytes or combination thereof in a first electrical dielectric medium of interest;
a second electrical dielectric medium of interest;
a first electrically small antenna tuned to radio frequencies of said apparatus first part A in the form of a feed suitable for exciting an electrically dielectric resonant structure of said first electrical dielectric medium of interest;
a second antenna tuned to a second radio frequency s;
an external radio system tuned to a second radio frequency s;
an electrical battery;
a fixed label;
a set of connections providing for the formation in the structure of conducting material comprising a circuit;
a circuit structure for power management from said battery;
a circuit structure comprising permanent digital memory;
a circuit structure comprising alterable digital memory;
a circuit structure comprising a digital processor;
a circuit structure comprising a radio frequency power amplifier connected to said first antenna tuned to radio frequencies of said apparatus first part connected to said feed suitable for exciting an electrically dielectric resonant structure;
a circuit structure comprising a circuit to alter the impedance of the antenna tuned to radio frequencies of said apparatus first part connected to said feed suitable for exciting an electrically dielectric resonant structure;
a circuit structure acting as a modulator for off-on-keying, (OOK) or amplitude shift keying, (ASK) modulation acting as a transmitter for a reference value, command and clock;
a circuit structure acting as an envelope detector demodulator for off-on-keying, (OOK) or amplitude shift keying, (ASK) modulation acting as a receiver for encoded RF modulation in supposition or summing as a response signal from a plurality of said apparatus first part A;
a structure comprising a RF transmitter and receiver at a second radio frequency s;
a visual indicator;
wherein said circuit structure comprising a radio frequency power amplifier connected to said first antenna tuned to radio frequencies of said apparatus first part excites an electrically dielectric resonant structure in an electrical dielectric medium of interest,
wherein said first electrical dielectric medium of interest has an electromagnetic wave number greater than or equal to three times said second dielectric medium of interest, and
wherein said part B apparatus is located at a boundary of first electrical dielectric medium of interest having an electromagnetic wave number greater than or equal to three times said second dielectric medium of interest and second dielectric medium of interest, and
wherein said circuit structure comprising a radio frequency power amplifier connected to said first antenna tuned to radio frequencies of said apparatus first part provides electrical energy to the plurality of said apparatus first part A,
wherein said circuit structure comprising a radio frequency transmitter acts as a modulator for off-on-keying, (OOK) or amplitude shift keying, (ASK) modulation acting as a transmitter for a reference value, commands, clock and other signals deemed necessary connected to said radio frequency power amplifier connected to said first antenna tuned to radio frequencies of said apparatus first part A provides a reference value, control signals, clock signal and other signals deemed necessary to the plurality of said apparatus first part A,
wherein said circuit structure comprising a radio frequency receiver alternatively acts as an envelope detector demodulator for off-on-keying, (OOK) or amplitude shift keying, (ASK) modulation acting as a receiver encoded RF modulation in supposition or summing as a response signal from a plurality of said apparatus first part A,
wherein said circuit structure comprising said permanent digital memory, alterable digital memory and digital processor is configured to perform a despreading operation on said received encoded RF modulation in supposition or summing as a response signal from a plurality of said apparatus first part A using both a priori stored identification values and encoding values,
wherein said circuit structure comprising said permanent digital memory, alterable digital memory and digital processor is configured to place the results of the despreading operation combined with a bit weight established by the transmitted reference value into memory corresponding to address locations corresponding to priori stored identification values of said apparatus first part A,
wherein said individual said information in said memory is filtered and decimated using said digital processor whereby the digital representation of said concentration of a chemical or biological analyte acting on said functionalized surface or temperature of each of said apparatus first part A is obtained in the manner of a successive approximation converter wherein said information is stored said in said memory,
wherein said circuit structure comprising said second antenna tuned to second radio frequency s receives signals from said external radio system and said structure comprising a radio transmitter and receiver said circuit structure comprising said permanent digital memory, alterable digital memory and digital processor receives an external command to transmit the set of information from memory corresponding to address locations corresponding to priori stored identification values of said apparatus first part A,
wherein said visual indicator can be triggered by either second radio frequency s receiver circuit structure or digital processor upon external or internal command,
wherein said information in said memory of said apparatus second part B is transmitted to said external radio system upon demand over said second radio frequency s radio link whereby each set of information concentration of a chemical or biological analyte information, temperature or other information deemed necessary combined with said identification value to uniquely identify said information from each of the plurality of said apparatus first part A,
thereby collecting and providing temperature, concentration of a chemical or biological analyte and ID value to external information processes inside an electrical dielectric medium of interest.

2. A method for controlling, clocking and synchronizing a number of sensing RFID tags forming a colony inside an electrical dielectric medium of interest for the purpose of communicating data derived thereof acting as radio frequency identification (RFID) tag said method comprising:
a plurality of first radio frequency identification (RFID) tag apparatus of claim 1 part A;
at least one of second radio frequency identification (RFID) tag apparatus of claim 1 part B;
wherein said method controls the colony consisting a plurality of first radio frequency identification (RFID) tag apparatus of claim 1 part A,
wherein said colony consisting a plurality of first radio frequency identification (RFID) tag apparatus of claim 1 part A are queried simultaneously and the response of the interrogated tags are collectively clock synchronized,
wherein said method uses a synchronization method implemented into said first radio frequency identification (RFID) tag apparatus of claim 1 part A as a clock & reset circuit,
wherein said method uses synchronization procedures in the colony is based on switching on/off the electromagnetic RF field of the apparatus of claim a B acting a Colony Coordinator tag that powers the Colony member tags,
wherein said method interrupts said wireless power supply generated by electromagnetic RF field of the named apparatus of claim 1 Part B acting a Colony Coordinator,
wherein all Colony member tags composed of a plurality of first radio frequency identification (RFID) tag apparatus of claim 1 Part A response can be instructed to either start with data transmission or, to send the next bit of their binary information,
wherein all Colony member tags composed of a plurality of first radio frequency identification (RFID) tag apparatus of claim 1 Part A response can be instructed to either take a chemical, temperature or other measurement as deemed appropriate,
wherein all Colony member tags composed of a plurality of first radio frequency identification (RFID) tag apparatus of claim 1 Part A response can be instructed to respond only if the detected value is above a reference value,
wherein all Colony member tags composed of a plurality of first radio frequency identification (RFID) tag apparatus of claim response can be instructed into synchronized time slots at the current bit index the bit information from all Colony members composed of a plurality of first radio frequency identification (RFID) tag apparatus of claim 1 part A superimposes on the RF channel thereby generating a specific overlaid signal,
wherein all Colony Coordinator tags composed of a of second radio frequency identification (RFID) tag apparatus of claim 1 Part B receiver side the superimposed signal in each time slot is captured and evaluated based on known priori identification and encoding values,
wherein all Colony Coordinator tags composed of a of second radio frequency identification (RFID) tag apparatus of claim 1 part B initiate every Colony member tags composed of a plurality of first radio frequency identification (RFID) tag apparatus of claim 1 Part A to start transmission at the same time the signaling can be done either by 1) turning off said Colony Coordinator antenna for a long time period and then start powering said Colony member tags periodically with short intermissions, or 2) begin with transmission by transmitting a modulated start bit in a time slot followed by transmitting the subsequently bit stream in regular sized time slots,
wherein said circuit logic in said clock & reset circuit is tuned to interpret request orders sent from said Colony Coordinator of claim 1 part A reader device based on capacitor discharge behavior and voltage comparator device,
wherein parallel to said circuit logic that detects the external clock synchronization request, a internal clock counter in said clock & reset circuit resets the bit index, and start increasing the count when the next intermission is registered,
wherein said Colony member tag acquires the actual bit position in the bit sequence in addition to the clock detection circuit a using a memory to preserve the bit index, wherein said memory storage device keeps the storage contents even if the colony tag is not powered for a short term,
wherein said Colony Coordinator device causes an intermission to signalize the next time slot for transmission, there before increasing the bit index an additional memory buffer stores temporarily the current bit index and induces the bit transmission, there after increasing the bit index a delayed rewritten in the bit index buffer thereby providing the required delay for stabilized rewriting,
thereby the method queries the colony of tags simultaneously and the response of the interrogated Colony member tags are collectively clock synchronized and data synchronized by the Colony Coordinator tags.

3. A method in conjunction with claim 2 for receiving sensor data from a number of sensing RFID tags forming a colony inside an electrical dielectric medium of interest for the purpose of communicating data derived thereof acting as radio frequency identification (RFID) tag said method comprising:
a plurality of first radio frequency identification (RFID) tag apparatus of claim 1 part A;
at least one of second radio frequency identification (RFID) tag apparatus of claim 1 part B;
wherein said method queries the colony consisting a plurality of first radio frequency identification (RFID) tag apparatus of claim 1 part A,
wherein said colony consisting a plurality of first radio frequency identification (RFID) tag apparatus of claim 1 part A are queried simultaneously and the response of the interrogated tags transmit at the same time if and only if the measured value is greater than the reference value transmitted in claim 2 by the second radio frequency identification (RFID) tag apparatus of claim 1 Part B,
wherein said method uses the method of claim 2 for controlling, clocking and synchronizing a number of said first radio frequency identification (RFID) tag apparatus of claim 1 part A by the second radio frequency identification (RFID) tag apparatus of claim 1 Part B,
wherein said method utilizes the second radio frequency identification (RFID) tag apparatus of claim 1 Part B said radio frequency receiver alternatively acting as an envelope detector demodulator for off-on-keying, (OOK) or amplitude shift keying, (ASK) modulation to act as a receiver of the encoded RF modulation in supposition or summing as a response signal from a plurality of first radio frequency identification (RFID) tag apparatus of claim 1 Part A,
wherein said second radio frequency identification (RFID) tag apparatus of claim 1 Part B performs a despreading operation on said received encoded RF modulation in supposition or summing as a response signal from a plurality of said first radio frequency identification (RFID) tag apparatus of claim 1 Part A using both a priori stored identification values and encoding values,
wherein the following steps are repeated on the plurality of tags,
a. said second radio frequency identification (RFID) tag apparatus of claim 1 Part B calculates a probability that an individual first radio frequency identification (RFID) tag apparatus of claim 1 Part A has responded indicating that individual said first radio frequency identification (RFID) tag apparatus of claim 1 Part A senses a measurement value higher than the reference value transmitted by the second radio frequency identification (RFID) tag apparatus of claim 1 Part B using the method of claim 2 and places the results of the despreading operation into an individual memory location reserved for the specific a priori stored identification value for that specific first radio frequency identification (RFID) tag apparatus of claim 1 Part A,
b. said second radio frequency identification (RFID) tag apparatus of claim 1 Part B calculates a combined with a bit weight established by the transmitted reference value of claim 2 and the probability that an individual first radio frequency identification (RFID) tag apparatus of claim 1 Part A has responded indicating that individual said first radio frequency identification (RFID) tag apparatus of claim 1 Part A senses a measurement value higher than the reference value and places the results of the bit-weight operation into an individual memory location reserved for the specific a priori stored identification value for that specific first radio frequency identification (RFID) tag apparatus of claim 1 Part A,
c. said second radio frequency identification (RFID) tag apparatus of claim 1 Part B filters and decimates said individual said combined bit weights in said memory whereby the digital representation of said concentration of a chemical or biological analyte acting on said functionalized surface of each sensor or temperature of that specific first radio frequency identification (RFID) tag apparatus of claim 1 Part A,
d. said second radio frequency identification (RFID) tag apparatus of claim 1 Part B optionally varies the reference values using the method of claim 2 to obtain in the manner of a successive approximation converter a variable resolution ensemble of the digital representation of said concentration of a chemical or biological analyte acting on said functionalized surface of each sensor or temperature of that specific first radio frequency identification (RFID) tag apparatus of claim 1 Part A, wherein said ensemble is stored said in said memory,
thereby the method queries the colony of tags simultaneously and the digital representation of said concentration of a chemical or biological analyte acting on said functionalized surface of each sensor or temperature of the interrogated Colony member tags are collectively obtained.

4. A System for sensing the concentration of a plurality of a chemical or biological analytes and the chemical or biological analytes temperature and communicating data derived thereof acting as radio frequency identification (RFID) tag, wherein the RFID tag is in direct contact with the chemical analyte said system comprising:
a plurality of first radio frequency identification (RFID) tag apparatus of claim 1 Part A;
at least one of second radio frequency identification (RFID) tag apparatus of claim 1 Part B;
said method of claim 3 for sensing the concentration of a plurality of a chemical or biological analytes and the chemical or biological analytes temperature and communicating data derived thereof acting as radio frequency identification (RFID) tag described above;
said first method of claim 2 for synchronizing a number of sensing RFID tags for the purpose of communicating data derived thereof acting as radio frequency identification (RFID) tag described above;
a label reader connected to a first mobile device apparatus, said device is connected to the internet;
an unknown number of other second mobile device and fixed apparatus, said devices are connected to the internet;
a computer analysis and storage element connected to the internet;
wherein said method queries the colony consisting a plurality of first radio frequency identification (RFID) tag apparatus described in claim 1,
wherein a binding operation of said plurality of first radio frequency identification (RFID) tag apparatus of claim 1 Part A to said second radio frequency identification (RFID) tag apparatus of claim 1 Part B,
wherein the second radio frequency identification (RFID) tag apparatus of claim a Part B pushes the inventory of first radio frequency identification (RFID) tag apparatus of claim 1 Part A to said computer using the internet,
wherein the second radio frequency identification (RFID) tag apparatus of claim 1 part B periodically queries the colony consisting of a plurality of second radio frequency identification (RFID) tag apparatus of claim 1 part A using the method of claim 2 and claim 3 and storing the plurality of a chemical or biological analytes and the chemical or biological analytes temperature data thus received combined with said stored ID numbers thereby acting as Colony Coordinator,
wherein upon demand by any of said unknown number of said other second mobile device and fixed apparatus said devices connected to the internet second radio frequency identification (RFID) tag apparatus of claim 1 part B acting as Colony Coordinator transfers said plurality of a chemical or biological analytes and the chemical or biological analytes temperature data received and ID numbers to said other second mobile device and fixed apparatus said devices connected to the internet,
wherein unknown number of said other second mobile device and fixed apparatus said devices connected to the internet transfers said chemical or biological analytes and the chemical or biological analytes temperature data and ID numbers to said computer using said internet,
wherein said System organizes large numbers of second radio frequency identification (RFID) tag apparatus of claim 1 part B acting as Colony Coordinator and by association first radio frequency identification (RFID) tag apparatus of claim 1 part A acting as Colony Members in a scalable manner,
wherein said computer analyzes chemical or biological analytes and the chemical or biological analytes temperature data and ID number thereby providing a computer operator with information thereby allowing said operator to make decisions on the carton referenced by the ID numbers based on said data thus obtained,
thereby said System organizes an even greater plurality of identification (RFID) tag apparatus of claim 1 part B acting as Colony Coordinator and by association first radio frequency identification (RFID) tag apparatus of claim 1 part A acting as Colony Members each reporting chemical, biological and temperature information into many colonies, said system obtaining data from thousands of Colony Member tags harvested by a plurality of Colony Coordinators and further said data from thousands of Colonies said System organizes groups of these Colonies each reporting chemical, biological and temperature information into Groups of Colonies said System decodes the temperature chemical and biological information and processes information from each of said Colony Member sensor tags in a time correlated database to form an electronic digital domain representation of said chemical, biological and temperature information for further analysis said System formats the time series database based on the interpreted chemical and biological information for relay back to a decision point thus creating actionable intelligence of decay at the carton and item level.

5. A radio frequency identification RFID tag apparatus of claim 1 wherein said apparatus provides an apparatus for sensing the concentration of a chemical or biological analyte and the chemical or biological analytes temperature and communicating data derived thereof acting as radio frequency identification (RFID) tag, wherein the RFID tag is in direct contact with the chemical analyte said radio frequency identification (RFID) tag.

6. A radio frequency identification RFID tag method of claims 2 and 3 wherein said methods provides a method for sensing the concentration of a chemical or biological analyte and the chemical or biological analytes temperature and communicating data derived thereof acting as radio frequency identification (RFID) tag, wherein the RFID tag is in direct contact with the chemical analyte.

7. A radio frequency identification RFID tag system of claim 5 wherein said method provides a method for sensing the concentration of a chemical or biological analyte and the chemical or biological analytes temperature and communicating data derived thereof acting as radio frequency identification (RFID) tag, wherein the RFID tag is in direct contact with the chemical analyte.

8. The RFID tag of claims 1, 2 and 3, wherein the communications signal and the electromagnetic power are at about a same radio frequency and the data reporting electromagnetic signal are at a different radio frequency.

9. A computer usable storage medium having a computer readable program code embodied therein, said computer readable program code containing instructions that when executed by a processor implement the method of claims 2, 3 and 5.

10. A system comprising a processor and a computer readable memory unit coupled to the processor, said memory unit containing instructions that when executed by the processor implement the system of claim 4, wherein the system comprises mobile devices commonly known as smart phones and tablets.

11. A radio frequency identification (RFID) apparatus of claim 1 wherein A radio frequency identification (RFID) apparatus made up of two parts, wherein a plurality of first named Part A also comprises an least one inductive coil and variable capacitor electrically in parallel with said small antenna in the form of a magnetic dipole of claim 1 and wherein second named Part B also comprises an least one inductive coil and variable capacitor electrically in parallel with said first small antenna in the form of a magnetic dipole of claim 1.

12. A method and additional apparatus for adjusting the resonant frequency of claims 1 and 11 wherein said variable capacitors are adjusted by commands from said apparatus Part B of claims 1 and 11 by measuring complex electrical power to said apparatus Part B of claims 1 and 11 circuit structure comprising said radio frequency power amplifier connected to said first antenna tuned to radio frequencies of said apparatus first part connected to said feed suitable for exciting an electrically dielectric resonant structure and or adding to apparatus Part A of claims 1 and 11 adjustable variable capacitors to at least one second electrically small antenna in the form of a magnetic dipole electromagnetically coupled to the first electrically small antenna of apparatus Part A of claims 1 and 11 in the form of a magnetic dipole said adjustable variable capacitors are adjusted by commands from said apparatus Part B of claims 1 and 11 and received by said apparatus Part A of claims 1 and 11.

13. An apparatus of claim 1 part A wherein said potentiostatic measurement circuit is replaced with a galvanometric measurement circuit;

14. An apparatus of claim 1 part B wherein said battery circuit and second radio external radio system tuned to a second radio frequency s methods of claims 2 and 3, system of claim 4 are replaced with a wired interface circuit to an external interface.

15. The radio frequency identification (RFID) apparatus of claim 1 made up of two parts, wherein said first electrical dielectric medium of interest has an electromagnetic wave number less than three times said second dielectric medium of interest and bounded by an electrical conductor.
